(19) United States
(12) Patent Application Publication
(10) Pub. No.: US 2025/0171960 A1
(43) Pub. Date: May 29, 2025

(54) SHEET MANUFACTURING APPARATUS AND METHOD OF MANUFACTURING SHEETS

(71) Applicant: SEIKO EPSON CORPORATION, Tokyo (JP)

(72) Inventors: Hidemasa KANADA, Matsumoto (JP); Yoshiyuki NAGAI, Shiojiri (JP); Yoshikazu NAGAI, Matsumoto (JP); Kazuma MIYAZAWA, Shiojiri (JP); Masahide NAKAMURA, Matsumoto (JP)

(21) Appl. No.: 18/959,755

(22) Filed: Nov. 26, 2024

(30) Foreign Application Priority Data
Nov. 28, 2023 (JP) 2023-200477

(51) Int. Cl. D21F 3/04; D21F 3/02; D21F 3/08; D21H 17/28

(52) U.S. Cl. CPC D21F 3/04; D21F 3/0281; D21F 3/08; D21H 17/28

(57) ABSTRACT

A sheet manufacturing apparatus includes: a deposition unit configured to deposit a material containing fibers to form a web; a humidification unit configured to moisten the web; a first roller configured to heat and dry the moistened web; a winding roller configured to wind a sheet around the first roller; and a pressing roller configured to press the sheet against the first roller.

The present application is based on, and claims priority from JP Application Serial Number 2023-200477, filed Nov. 28, 2023, the disclosure of which is hereby incorporated by reference herein in its entirety.

### BACKGROUND

### 1. Technical Field

The present disclosure relates to a sheet manufacturing apparatus and a method of manufacturing sheets.

### 2. Related Art

JP-A-2016-204821 discloses a sheet manufacturing apparatus that deposits fibers to form a web and heats and presses the web by using a pair of heating and pressing rollers to form a sheet while continuously transporting the web.

However, because the sheet manufacturing apparatus in JP-A-2016-204821 dries a formed sheet, downstream of the heating and pressing rollers in the sheet transportation direction, the sheet contracts. This increases the likelihood of the occurrence of deformation such as wrinkles in the sheet.

### SUMMARY

A sheet manufacturing apparatus includes: a deposition unit configured to deposit a material containing fibers to form a web; and a forming unit configured to press and heat the web to form the web into a sheet, and the forming unit includes a first roller configured to heat the web and the sheet, a second roller between which and the first roller the web is nipped, a winding roller located downstream of the first roller in a transportation direction in which the sheet is transported and configured to wind the sheet around the first roller, and a pressing roller configured to press the sheet wound around the first roller against the first roller.

### BRIEF DESCRIPTION OF THE DRAWINGS

FIG. 1 is a schematic side view of a sheet manufacturing apparatus according to Embodiment 1.

FIG. 2 is a schematic side view of a forming unit included in the sheet manufacturing apparatus.

FIG. 3 is a schematic side view of the forming unit included in the sheet manufacturing apparatus, illustrating how a web is formed into a sheet.

### DESCRIPTION OF EMBODIMENTS

Hereinafter, the present disclosure will be described with reference to an embodiment. In the following embodiment, as a sheet manufacturing apparatus 1 that manufactures sheets P1, P2, and P3 from a material containing fibers, a sheet manufacturing apparatus 1 that recycles scraps of paper such as used paper in a dry process will be described as an example with reference to the drawings. The sheet manufacturing apparatus 1 of the present disclosure is not limited dry processes but may be applied to wet processes. A dry process in the present embodiment denotes that the step of defibrating mainly used paper is not performed in liquid but performed in air such as the atmosphere.

In each figure, the same members are denoted by the same symbols, and repetitive description will be omitted. In this specification, “same”, “identical”, and “same time” do not refer to only “being exactly the same”. For example, in this specification, “same”, “identical”, and “same time” include cases of being the same with measurement errors taken into account. For example, in this specification, “same”, “identical”, “same time” include cases of being the same with manufacturing variations in members taken into account”.

In addition, for example, in this specification, “same”, “identical”, and “same time” include cases of being the same within a range in which functions are not impaired. Hence, for example, when it is mentioned that “two dimensions are the same”, measurement errors and variations in manufacturing members are taken into account.

In each figure, X, Y, and Z indicate three space axes orthogonal to one another. In the present specification, the directions parallel to these axes are referred to as the X-axis direction, the Y-axis direction, and the Z-axis direction. To indicate one side of a direction, the positive direction is expressed as “+”, the negative direction is expressed as “−”, and the positive and negative symbols are used in parallel with a directional indication. In the following description, the direction in which an arrow in each figure points is the +direction, and the direction opposite to the arrow is the −direction.

The Z-axis direction corresponds to the gravitational direction. The +Z direction corresponds to the vertically upward direction, and the −Z direction to the vertically downward direction. In the following description, the plane including the X-axis and the Y-axis is referred to as the X-Y plane, the plane including the X-axis and the Z-axis as the X-Z plane, and the plane including the Y-axis and the Z-axis as the Y-Z plane. The X-Y plane corresponds to the horizontal plane. In the following description, the three X, Y, and Z space axes not limited to either the positive or negative direction are referred to as the X-axis, the Y-axis, and the Z-axis.

The X-axis direction is a horizontal direction parallel to the installation surface which is a horizontal surface on which the sheet manufacturing apparatus 1 is installed. The Y-axis direction is a horizontal direction parallel to the installation surface on which the sheet manufacturing apparatus 1 is installed. The Z-axis direction is the direction of the normal line of the installation surface on which the sheet manufacturing apparatus 1 is installed, and the Z-axis corresponds to the height direction of the sheet manufacturing apparatus 1.

In the following description, the +Z direction is sometimes referred to as “the upward direction”, and the −Z direction as “the downward direction”. In the following description, in the sheet manufacturing apparatus 1, the side in the transportation direction of raw material, a web, a sheet, and the like is sometimes referred to as “downstream”, and the opposite side in the transportation direction as “upstream”. For convenience of illustration, the size of each member differs from the actual one.

### 1. Embodiment 1

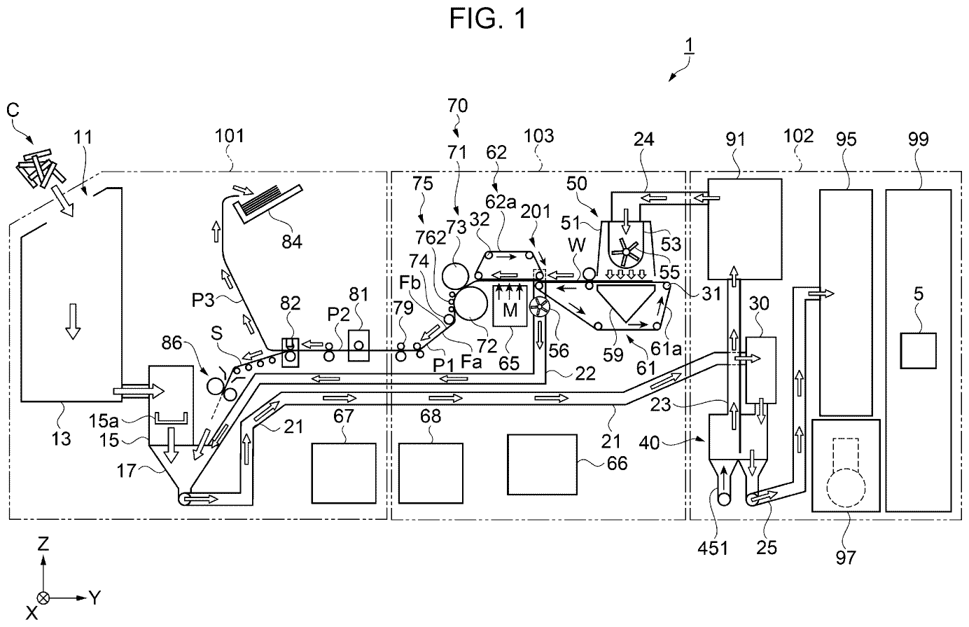

As illustrated in FIG. 1, the sheet manufacturing apparatus 1 of the present embodiment includes a first set of units 101, a second set of units 102, and a third set of units 103. The first set of units 101, the second set of units 102, and the third set of units 103 are supported by a frame (not illustrated).

In side view of the sheet manufacturing apparatus 1 from the-X direction, the first set of units 101, the third set of units 103, and the second set of units 102 are located from the −Y direction side to the +Y direction side. In FIG. 1, the directions in which used paper C, a web W, sheets P1, P2, and P3, slit pieces S, and unnecessary scraps move are indicated by white arrows.

The sheet manufacturing apparatus 1 manufactures sheets P3 from used paper C which is a material containing fibers. Since the sheet manufacturing apparatus 1 of the present embodiment is configured to manufacture sheets P3 from used paper C, used paper C is recycled, which reduces the amount of wasted used paper C. Hence, the sheet manufacturing apparatus 1 of the present embodiment contributes to achieving sustainable development goals (SDGs) such as Goal 12 “Ensure sustainable consumption and production patterns”. As a matter of course, the sheets P3 may be manufactured from not only used paper but also various kinds of material containing fibers such as used clothes.

Used paper C is transported from the first set of units 101 to the second set of units 102 through a pipe 21 passing through inside the third set of units 103. Used paper C is subjected to defibration and the like in the second set of units 102 and turns to fibers, to which a binder as a binding agent and the like is added, and a mixture is obtained. The mixture is transported to the third set of units 103 through a pipe 24. The mixture is turned into a web W in the third set of units 103, and the web W is formed into a belt-like sheet P1. The belt-like sheet P1 is cut in the first set of units 101 and turned into sheets P3.

The first set of units 101 includes a buffer tank 13, a constant-amount supply unit 15, a confluence portion 17, and the pipe 21. In the first set of units 101, these units are located in the order mentioned above from upstream to downstream. The first set of units 101 also includes a first cutting unit 81, a second cutting unit 82, a tray 84, and a shredding unit 86.

The first cutting unit 81 and the second cutting unit 82 cut the belt-like sheet P1 into sheets P3 having a specified shape. The first set of units 101 includes a water supply unit 67. The water supply unit 67 is a water storage tank. The water supply unit 67 supplies first and second humidification units 65 and 66 described later with water for moistening through water supply pipes (not illustrated).

Used paper C is supplied to the buffer tank 13 through a raw-material supply port 11. The used paper C contains fibers such as cellulose and is, for example, scraps of shredded used paper. Humidified air is supplied to the inside of the buffer tank 13 from the second humidification unit 66 included in the third set of units 103.

The used paper C to be defibrated is temporarily stored in the buffer tank 13 and is then transported to the constant-amount supply unit 15 according to the operation of the sheet manufacturing apparatus 1. The sheet manufacturing apparatus 1 may include a shredder for shredding used paper C and the like upstream of the buffer tank 13.

The constant-amount supply unit 15 includes a weighing instrument 15a and a supply mechanism (not illustrated). The weighing instrument 15a weighs the mass of used paper C. The supply mechanism supplies used paper C weighed by the weighing instrument 15a to the confluence portion 17 located downstream. Every time the constant-amount supply unit 15 weighs out a specified mass of used paper C with the weighing instrument 15a, the constant-amount supply unit 15 supplies it to the confluence portion 17 located downstream by using the supply mechanism.

The weighing instrument 15a may employ either a digital weighing mechanism or an analog one. Specific examples of the weighing instrument 15a include physical sensors such as load cells, spring scales, and balances. In the present embodiment, a load cell is used as the weighing instrument 15a. The specified mass of used paper C weighed by the weighing instrument 15a typically ranges, for example, from several grams to several tens of grams.

The supply mechanism may employ a vibratory feeder or the like. A configuration in which the supply mechanism is included in the weighing instrument 15a is also possible.

The weighing and supplying processes for used paper C in the constant-amount supply unit 15 are batch processes. Used paper C is intermittently supplied from the constant-amount supply unit 15 to the confluence portion 17. The constant-amount supply unit 15 may include a plurality of weighing instruments 15a and may operate the plurality of the weighing instruments 15a at different timings to improve the efficiency of weighing.

In the confluence portion 17, shredded pieces of slit pieces S supplied from the shredding unit 86 are added to and mixed in the used paper C supplied from the constant-amount supply unit 15. The slit pieces S and the shredding unit 86 will be described later. The used paper C in which the shredded pieces mentioned above are mixed flows from the confluence portion 17 into the pipe 21.

Through the pipe 21, an air flow generated by a blower (not illustrated) transports the used paper C from the first set of units 101 to the second set of units 102.

The second set of units 102 includes a defibration machine 30 which is a dry defibration machine, a separation machine 40, a pipe 23, a mixing unit 91, and a pipe 24. In the second set of units 102, these units are located in the order mentioned above from upstream to downstream. The second set of units 102 also includes a collection unit 95, a compressor 97, a power supply unit 99, a pipe 25 coupled to the separation machine 40, and an air-flow pipe 451.

The used paper C transported through the pipe 21 flows into the defibration machine 30. The defibration machine 30 defibrates the used paper C supplied from the constant-amount supply unit 15 in a dry process and turns the used paper C into fibers. The defibration machine 30 may employ a mechanical defibration mechanism or the like that defibrates used paper C by using mechanical force. The defibration machine 30 defibrates intertwined fibers included in scraps of paper, and the used paper C turns to a defibrated material containing fibers, which is transported to the separation machine 40.

Since the defibration machine 30 of the present embodiment defibrates used paper C into fibers in a dry process, the amount of used water and the amount of discharge water can be reduced, compared with those of a wet defibration method that performs defibration in water. Thus, the defibration machine 30 of the present embodiment contributes to achieving sustainable development goals (SDGs) such as Goal 6 “Ensure availability and sustainable management of water and sanitation for all”. The defibration machine 30 of the present embodiment also contributes to achieving sustainable development goals (SDGs) such as Goal 14 “Conserve and sustainably use the oceans, seas and marine resources for sustainable development”.

Since the defibration machine 30 of the present embodiment does not require the defibrated material to be dried, the amount of carbon dioxide produced in the step of defibrating used paper C can be reduced. Thus, the defibration machine 30 of the present embodiment contributes to achieving sustainable development goals (SDGs) such as Goal 13 “Take urgent action to combat climate change and its impacts”.

The separation machine 40 separates fibers obtained by defibration. Specifically, the separation machine 40 removes components unnecessary for manufacturing sheets P3, included in the fibers. The separation machine 40 separates relatively long fibers and relatively short fibers. Relatively short fibers can degrade the strength of sheets P3, so that relatively short fibers are separated and removed by the separation machine 40. The separation machine 40 also removes coloring materials, additives, and the like contained in used paper C. The separation machine 40 is of a disk type.

Humidified air is supplied to the inside of the separation machine 40 from the second humidification unit 66 of the third set of units 103.

Relatively short fibers and the like are removed from the fibers obtained by defibration, and the resultant fibers are transported through the pipe 23 to the mixing unit 91 by the air flow generated by a blower (not illustrated) located at the distal end of the air-flow pipe 451. The unnecessary components such as relatively short fibers and coloring materials are discharged through the pipe 25 into the collection unit 95.

The mixing unit 91 mixes a binder and the like with fibers in air to produce a mixture. Although illustration is omitted, the mixing unit 91 includes a flow path through which fibers are transported, a fan, a hopper, a supply pipe, and a valve.

The hopper communicates with the flow path of fibers through the supply pipe. The valve is located on the supply pipe between the hopper and the flow path. The hopper is for supplying a binder such as starch into the flow path. The valve is for adjusting the mass of the binder supplied from the hopper into the flow path. With this configuration, the mixing ratio of fibers and the binder is adjusted.

The mixing unit 91 may include not only the constituents mentioned above for supplying a binder but also similar constituents for supplying a coloring material, an additive, and the like.

The fan of the mixing unit 91 generates an air flow, which mixes the binder and the like with fibers in air to produce a mixture while transporting the fibers downstream. The mixture flows from the mixing unit 91 into the pipe 24.

The collection unit 95 includes a filter (not illustrated). The filter filters out unnecessary components such as relatively short fibers transported by an air flow through the pipe 25.

The compressor 97 generates compressed air. The filter mentioned above can be clogged by fine particles or the like included in the unnecessary components. The compressed air generated by the compressor 97 is blown to the filter to blown away attached particles, so that the filter can be cleaned.

The power supply unit 99 includes an electric-power supply apparatus (not illustrated) that supplies the sheet manufacturing apparatus 1 with electric power. The power supply unit 99 distributes the electric power supplied from the outside to units in the sheet manufacturing apparatus 1. The power supply unit 99 includes a control unit 5. The control unit 5 is electrically coupled to the units in the sheet manufacturing apparatus 1 to control the operation of these units in an integrated manner.

The control unit 5 may include one or more processors that execute various processes according to a program, one or more dedicated hardware circuits such as application specific integrated circuits that execute at least part of the various processes, or a combination of those. The processor includes a CPU and memory such as RAM and ROM, and the memory stores program codes or instructions configured to cause the CPU to execute processing. Examples of the memory, in other words, a computer readable medium, include various readable media that a general-purpose or dedicated computer can access.

The third set of units 103 deposits the mixture containing fibers and compresses it to form a belt-like sheet P1 as recycled paper. The third set of units 103 includes a deposition unit 50, a first transportation unit 61, a second transportation unit 62, the first humidification unit 65, the second humidification unit 66, a drainage unit 68, and a forming unit 70 which is a sheet forming unit.

In the third set of units 103, the deposition unit 50, the first transportation unit 61, the second transportation unit 62, the first humidification unit 65, and the forming unit 70 are located from upstream to downstream in the order mentioned above. The second humidification unit 66 is located below the first humidification unit 65.

The deposition unit 50 forms a web W by depositing the mixture containing fibers, supplied from the separation machine 40, by using an air flow and the gravity. The deposition unit 50 includes a drum member 53, a blade member 55 located in the drum member 53, a housing 51 that houses the drum member 53, and a suction unit 59. The mixture is supplied through the pipe 24 into the drum member 53.

The first transportation unit 61 is located under the deposition unit 50. The first transportation unit 61 includes a first transportation belt 61a and tension rollers 31 around which the first transportation belt 61a is stretched. The suction unit 59 faces the drum member 53 with the first transportation belt 61a in between in the Z-axis direction.

The blade member 55 is located inside the drum member 53 and rotationally driven by a motor (not illustrated). The drum member 53 is a semi-cylindrical sieve. The side surface of the drum member 53 facing downward has a net having a function of a sieve. The drum member 53 allows fibers and particles such as a mixture smaller than the size of the mesh of the net of the sieve to pass from the inside to the outside.

The mixture is agitated in the drum member 53 by the rotating blade member 55 and is discharged to the outside of the drum member 53. Humidified air is supplied from the second humidification unit 66 into the drum member 53.

The suction unit 59 is located under the drum member 53. The suction unit 59 suctions air in the housing 51 through a plurality of holes in the first transportation belt 61a. This operation generates an air flow for depositing the mixture onto the first transportation belt 61a. The plurality of holes in the first transportation belt 61a allow air to pass through but are difficult for fibers and a binder and the like included in the mixture to pass through. This causes the mixture discharged to the outside of the drum member 53 to be suctioned together with air downward. The suction unit 59 is a suction device such as a blower.

The mixture is dispersed in the air inside the housing 51, deposited onto the upper surface of the first transportation belt 61a by the gravity and the air flow generated by the suction unit 59, and turned into a web W.

The first transportation belt 61a is an endless belt stretched around the tension rollers 31. The first transportation belt 61a rotates counterclockwise as viewed from the-X direction in FIG. 1 by the rotation of the tension rollers 31. This causes the mixture to be continuously deposited onto the first transportation belt 61a to form the web W. The web W contains a relatively large amount of air and is soft and swollen. The first transportation unit 61 transports the formed web W downstream by the rotation of the first transportation belt 61a.

The second transportation unit 62 is located downstream of the first transportation unit 61 and transports the web W, replacing the first transportation unit 61. The second transportation unit 62 peels the web W off the upper surface of the first transportation belt 61a and transports it toward the forming unit 70. The second transportation unit 62 is located over the transportation path of the web W and slightly upstream of the return start point of the first transportation belt 61a. A portion of the second transportation unit 62 on the +Y direction side and a portion of the first transportation belt 61a on the −Y direction side partially overlap each other in the vertical direction.

The second transportation unit 62 includes a second transportation belt 62a, a plurality of rollers 32, and a suction mechanism (not illustrated). The second transportation belt 62a has a plurality of holes that allows air to pass through. The second transportation belt 62a is stretched around the plurality of rollers 32 and rotates by the rotation of the rollers 32.

The second transportation unit 62 causes the upper surface, which is one surface, of the web W to be attracted to the lower surface of the second transportation belt 62a by suction of a negative pressure generated by the suction mechanism. The second transportation belt 62a rotates in this state, so that the web W attracted to the second transportation belt 62a by suction is transported downstream.

A cleaning unit 201 is located in a region starting from the portion where the first transportation unit 61 and the second transportation unit 62 overlap each other and extending below these units. The cleaning unit 201 includes a brush roller or the like for removing residual fibers attached to the first transportation belt 61a and the second transportation belt 62a.

The cleaning unit 201 is coupled to a fiber transportation pipe 22 for transporting the residual fibers collected by the cleaning unit 201 to the defibration machine 30. Specifically, the cleaning unit 201 is coupled to the defibration machine 30 with the fiber transportation pipe 22, the confluence portion 17, and the pipe 21 interposed therebetween.

The confluence portion 17 is coupled to the buffer tank 13, the fiber transportation pipe 22, and the defibration machine 30. The residual fibers collected by the cleaning unit 201 flow through the fiber transportation pipe 22, the confluence portion 17, and the pipe 21 into the defibration machine 30. The fiber transportation pipe 22 has a rotary valve 56 in which blades rotate to move residual fibers fallen from above downward.

The residual fibers collected by the cleaning unit 201 are transported to the defibration machine 30 through the fiber transportation pipe 22. This configuration reduces the frequency of the user removing the residual fibers attached to the first transportation belt 61a and the second transportation belt 62a, in other words, the frequency of maintenance. This reduces the amount of residual fibers disposed as waste and thus reduces waste of the raw material.

The first humidification unit 65 moistens the web W containing fibers deposited in the deposition unit 50 of the third set of units 103. Specifically, the first humidification unit 65 is, for example, a mist humidifier which moistens the web W being transported by the second transportation unit 62 by supplying the web W with mist M from the lower side. The first humidification unit 65 is located under the second transportation unit 62 and faces the web W being transported by the second transportation unit 62 in the Z-axis direction. The first humidification unit 65 may employ, for example, an ultrasonic humidification device or the like.

The moisture content of the web W to which moisture was added by the first humidification unit 65 is, for example, 12 mass % or more and 40 mass % or less. Moistening the web W by using the mist M promotes the function of starch as a binder and improves the strength of sheets P3.

Since the first humidification unit 65 moistens the web W from below, it prevents droplets originating from the mist from falling onto the web W. Since the first humidification unit 65 moistens the web W from the surface opposite to the surface in contact with the second transportation belt 62a, it prevents the web W from adhering to the second transportation belt 62a. The second transportation unit 62 transports the web W toward the forming unit 70.

The forming unit 70 presses and heats the moistened web W to form it into the belt-like sheet P1. The forming unit 70 has a processing roller pair 71 including a first roller 72 configured to heat the web W and the sheet P1 and a second roller 73 between which and the first roller 72 the web W can be nipped.

The first roller 72 and the second roller 73 nip the web W and rotate while pressing and heating the web W to form it into the sheet P1 and send the sheet P1 downstream in the transportation direction. The detailed configuration of the forming unit 70 will be described later.

When the web W is passing through the forming unit 70, air in the web W, containing a relatively large amount of air and being soft, is reduced, and the fibers are bound one another by a binder such as starch, so that the belt-like sheet P1 is formed. The belt-like sheet P1 is transported by a transportation roller pair 79 located downstream of the processing roller pair 71 and a winding roller 74 toward the first set of units 101.

The second humidification unit 66 is located below the first humidification unit 65. The second humidification unit 66 may employ an evaporative humidification device. Examples of evaporative humidification devices include one in which air is blown to a moistened nonwoven fabric to evaporate moisture and produce humidified air.

The second humidification unit 66 humidifies specified regions in the sheet manufacturing apparatus 1. The specified regions refer to one or more of the buffer tank 13, the separation machine 40, and the drum member 53 of the deposition unit 50. Specifically, humidified air is supplied from the second humidification unit 66 through a plurality of pipes (not illustrated) to the regions mentioned above. The humidified air reduces electrostatic charge of used paper C, fibers, and the like in the units mentioned above and prevents adhesion of used paper C, fibers, and the like to members due to static electricity.

The drainage unit 68 is a drain tank. The drainage unit 68 collects and stores water that is used in the first humidification unit 65, the second humidification unit 66, and the like and has become waste water. The drainage unit 68 is configured to be removed from the sheet manufacturing apparatus 1 as necessary to dispose stored water.

The belt-like sheet P1 transported to the first set of units 101 reaches the first cutting unit 81. The first cutting unit 81 cuts the belt-like sheet P1 in the direction intersecting the transportation direction, for example, the X-axis direction. The belt-like sheet P1 is cut into cut sheets P2 by the first cutting unit 81. The cut sheets P2 are transported from the first cutting unit 81 to the second cutting unit 82.

The second cutting unit 82 cuts the cut sheet P2 in the transportation direction, for example, the Y-axis direction. Specifically, the second cutting unit 82 cuts the cut sheet P2 at positions near both sides in the X-axis direction. This process turns the cut sheet P2 into a sheet P3 having a specified shape, for example, the A4 size, the A3 size, or the like.

When the cut sheet P2 is cut into the sheet P3 by the second cutting unit 82, slit pieces S which are scraps are produced. The slit pieces S are transported to substantially in the −Y direction and reach the shredding unit 86 which is a shredder. The shredding unit 86 shreds the slit pieces S into shredded pieces and supplies them to the confluence portion 17. A mechanism for weighing the shredded pieces of slit pieces S and supplying them to the confluence portion 17 may be located between the shredding unit 86 and the confluence portion 17.

The sheet P3 is transported substantially upward and stacked on the tray 84. Through these processes, the sheets P3 are manufactured in the sheet manufacturing apparatus 1. The sheets P3 can be used, for example, as alternatives to copy paper sheets.

Next, the detailed configuration of the forming unit 70 will be described. Since starch is used as a binder to form the sheet P1 in the present embodiment, moisture needs to be added to the web W containing starch. Hence, the moisture content of the web W is relatively high, and for example, when moisture evaporates from the formed sheet P1, wrinkles or the like are likely to occur, making it difficult to keep the smoothness of the sheet P1.

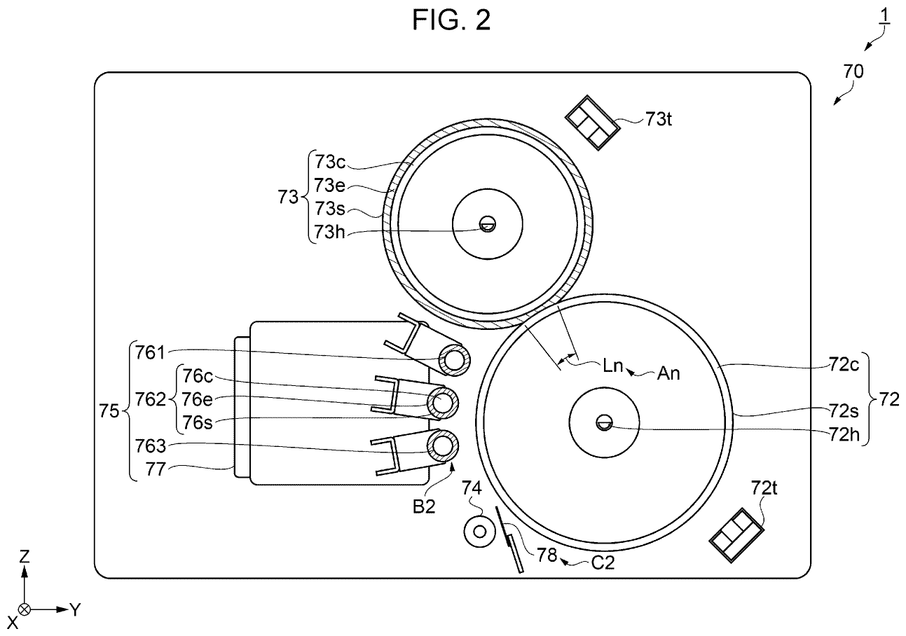

To address this, the forming unit 70 includes not only the processing roller pair 71 mentioned above but also the winding roller 74, a pressing mechanism 75 including a pressing roller 762, and a peeling portion 78 (see FIG. 2). The winding roller 74 is located downstream of the first roller 72 in the transportation direction and winds the sheet P1 around the first roller 72. The pressing roller 762 included in the pressing mechanism 75 is configured to press the sheet P1 wound around the first roller 72 against the first roller 72.

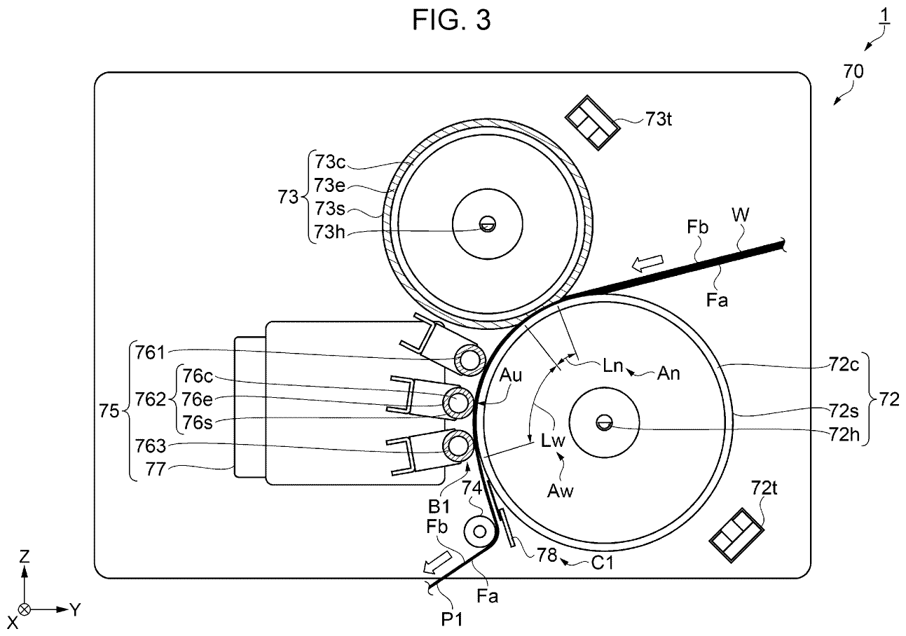

As illustrated in FIGS. 2 and 3, the rotation axes of the first roller 72 and the second roller 73 included in the processing roller pair 71 are parallel to the X-axis direction. As illustrated in FIG. 3, the first roller 72 is located on the −Z direction side of the transportation path on which the web W is transported. In FIGS. 2 and 3, the surface of the web W that makes contact with the second transportation belt 62a is indicated as a second side Fb, and the surface of the web W opposite to the second side Fb and moistened by the first humidification unit 65 is indicated as a first side Fa. In FIGS. 1 to 3, the surface of the sheet P1 on the same side as the second side Fb of the web W is indicated as the second side Fb, and the surface of the sheet P1 on the same side as the first side Fa of the web W is indicated as the first side Fa.

The second roller 73 is located on the +Z direction side of the transportation path. The rotation axis of the second roller 73 is located on the +Z direction side and on the −Y direction side of the rotation axis of the first roller 72. The forming unit 70 includes a second-roller moving mechanism (not illustrated) configured to move the second roller 73 between a nipping position illustrated in FIGS. 2 and 3 and a nipping release position (not illustrated). When the second roller 73 is at the nipping position, the web W can be nipped between the first roller 72 and the second roller 73. When the second roller 73 is at the nipping release position, the second roller 73 is at a position in a direction away from the first roller 72 relative to the nipping position, and the web W cannot be nipped between the first roller 72 and the second roller 73.

The first roller 72 is rotationally driven by a drive motor (not illustrated). The second roller 73 is a driven roller that is not driven by a drive motor and follows the rotation of the first roller 72. For example, when the second roller 73 is in contact with the first roller 72, and the first roller 72 rotates counterclockwise as viewed from the-X direction, the second roller 73 rotates clockwise.

The width dimensions in the X-axis direction of the first roller 72 and the second roller 73 are larger than the width dimensions in the X-axis direction of the web W transported and the sheet P1 formed. With this configuration, the entire region of the web W in the X-axis direction can be nipped by the first roller 72 and the second roller 73.

In the configuration of the present embodiment, the surface of the first roller 72 is harder than the surface of the second roller 73. Specifically, the first roller 72 is composed of a metal, and the second roller 73 is composed of a metal and a rubber covering the metal.

More specifically, the first roller 72 includes, for example, a hollow core metal 72c composed of aluminum, iron, stainless steel, or the like. The surface of the first roller 72 has a surface layer 72s composed of a fluororesin, for example, polytetrafluoroethylene (PTFE). Examples of the fluororesin that can be used include tetrafluoroethylene-perfluoroalkyl vinyl ether copolymer (PFA), tetrafluoroethylene-hexafluoropropylene copolymer (FEP), and tetrafluoroethylene-ethylene copolymer (ETFE).

Alternatively, the surface of the first roller 72 may have a surface layer 72s composed of a silicone resin or the like. The surface layer 72s increases non-adhesiveness to the web W and the sheet P1. The surface layer 72s reduces wear and damage to the core metal 72c. The first roller 72 in the present embodiment has, for example, an outer diameter of 130 mm.

The second roller 73 includes, for example, a hollow core metal 73c composed of aluminum, iron, stainless steel, or the like. The surface of the core metal 73c is covered with an elastic layer 73e composed of a rubber such as silicone rubber and urethane rubber.

It is preferable that the hardness of the elastic layer 73e be rubber hardness A10 or more and A35 or less, and it is more preferable that it be rubber hardness A20 or more and A30 or less. The rubber hardness refers to the hardness of type A durometer specified in JIS (Japan Industrial Standard) K6253-3:2012 (Rubber, vulcanized or thermoplastic—Determination of hardness—Part 3: Durometer method).

It is preferable that the thickness of the elastic layer 73e be 1 mm or more and 10 mm or less, and it is more preferable that it be 1 mm or more and 5 mm or less. The surface of the elastic layer 73e is covered with a surface layer 73s composed of a fluororesin layer or a tube containing a fluororesin.

Examples of the fluororesin that can be used include polytetrafluoroethylene (PTFE) and tetrafluoroethylene-perfluoroalkyl vinyl ether copolymer (PFA). Other examples of the fluororesin that can be used include tetrafluoroethylene-hexafluoropropylene copolymer (FEP) and tetrafluoroethylene-ethylene copolymer (ETFE). The surface layer 73s increases non-adhesiveness to the web W and the sheet P1. The surface layer 73s reduces wear and damage to the elastic layer 73e.

Since the first roller 72 and the second roller 73 press the web W, the web W is compressed in the thickness direction and made thinner, and this increases the fiber density of the web W. It is preferable that the pressure exerted on the web W by the first roller 72 and the second roller 73 nipping the web W be 0.1 MPa or more and 15 MPa or less, and it is more preferable that it be 0.2 MPa or more and 10 MPa or less. It is further preferable that the pressure exerted on the web W by the first roller 72 and the second roller 73 nipping the web W be 0.4 MPa or more and 8 MPa or less.

Such pressure ranges mitigate deterioration of fibers and enable the sheet P1 having favorable strength to be manufactured again by using, as a raw material, the defibrated material produced by defibrating manufactured sheets P1 and P3. The second roller 73 in the present embodiment has, for example, a core metal 73c with a diameter of 96 mm, an elastic layer 73e with a thickness of 2 mm, and a surface layer 73s. The second roller 73 in the present embodiment has an outer diameter of 100 mm.

The pressing load applied by the second roller 73 to the first roller 72, when nipping and pressing the web W, is set within a range from 1000 N to 4000 N, for example, to 2500 N.

As illustrated in FIGS. 2 and 3, the first roller 72 and the second roller 73 respectively include heaters 72h and 73h within for heating as heating mechanisms. The heaters 72h and 73h may employ, for example, halogen heaters. The surface temperatures of the first roller 72 and the second roller 73 are detected by temperature detection units 72t and 73t. The temperature detection units 72t and 73t may be non-contact temperature sensors or contact temperature sensors including a contact portion configured to be in contact with a surface of a temperature detection target.

According to the surface temperatures of the first roller 72 and the second roller 73 obtained by the temperature detection units 72t and 73t, driving of the heaters 72h and 73h is controlled. This enables the surface temperatures of the first roller 72 and the second roller 73 to be kept at specified temperatures. For example, it is preferable that the surface temperature of the first roller 72 be 100° C. or more and 130° C. or less, and it is preferable that the surface temperature of the second roller 73 be 80° C. or more and 100° C. or less. The pressing roller 762 does not include a heater for heating within. Hence, although heat can be transferred from the first roller 72 to the pressing roller 762, the surface temperature of the pressing roller 762 is lower than the surface temperatures of the first roller 72 and the second roller 73.

Since pressing and heating of the web W are performed simultaneously in the forming unit 70, the configuration of the sheet manufacturing apparatus 1 can be simple.

The temperature of the moisture contained in the web W increases, and then the moisture evaporates. Simultaneously, the web W is made thinner, which increases the fiber density. Heat increases the temperature of the moisture and the starch, and the pressure increases the fiber density. In addition, the starch gelatinizes, and then the moisture evaporates, so that the fibers are put into a state in which they can be bonded to one another with the gelatinized starch interposed therebetween.

The hardnesses of the first roller 72 and the second roller 73 included in the processing roller pair 71 in the present embodiment differ. As illustrated in FIG. 3, when the first roller 72 and the second roller 73 nip the web W, the surface of the second roller 73 at the nipping position is stably recessed due to the pressing pressure of the first roller 72.

This enables a nipping length Ln to be kept constant and stabilizes the pressure on a nipping portion An. Since the web W can be pressed and heated in this state, the fibers in the web W can be reliably put into a state in which they can be bonded to one another, which makes it possible to form a smooth sheet P1.

The nipping portion An refers to the portion where the web W is pressed by the first roller 72 and the second roller 73, and the nipping length Ln is the dimension of the nipping portion An in the transportation direction of the web W. The nipping length Ln corresponds to the length dimension from the nipping start position at which the first roller 72 and the second roller 73 start nipping the web W to the nipping end position at which the first roller 72 and the second roller 73 end the nipping. For example, the nipping length Ln in the present embodiment is set within a range from 6 mm to 16 mm, for example, to 10 mm. The nipping length Ln is substantially uniform in the nipping portion An in the X-axis direction.

Since the web W in the nipping portion An is nipped by the first roller 72 and the second roller 73, the moisture added to the web W is less likely to be discharged to the outside. Hence, the portion of the sheet P1 downstream of the nipping portion An in the transportation direction has a high moisture content and is soft. Hence, the sheet P1 easily deforms due to the stress in transportation, and wrinkles or the like can occur.

To address this, the present embodiment has a winding portion Aw on the surface of the first roller 72, following the downstream portion of the nipping portion An for evaporating moisture from the formed sheet P1. The winding portion Aw is a portion of the surface of the first roller 72 that is located downstream of the nipping end position of the nipping portion An and with which the first side Fa of the sheet P1 wound around the first roller 72 is in contact.

The downstream end of the winding portion Aw in the transportation direction is higher than, in other words, on the +Z direction side of, the lowermost end of the surface of the first roller 72. Hence, when the sheet Pl on the winding portion Aw is heated by the first roller 72, air near the surface of the first roller 72 on the −Y direction side of the lowermost end of the first roller 72 is also heated by the first roller 72.

On the vertically upward side, in other words, on the +Z direction side, of the winding portion Aw is located the surface of the second roller 73. Hence, when the sheet P1 on the winding portion Aw is heated by the first roller 72, air near the surface of the second roller 73 on the +Y direction side of the lowermost end of the second roller 73 is also heated by the second roller 73.

Hence, it can be expected that the heated air heats a portion near the upstream end in the transportation direction of the sheet P1 wound around the winding portion Aw, also from the second side Fb.

To form the winding portion Aw on the surface of the first roller 72, the forming unit 70 has the winding roller 74. The winding roller 74 is located downstream of the processing roller pair 71 in the transportation direction. The winding roller 74 winds the sheet P1 formed by the processing roller pair 71 around the first roller 72.

The rotation axis of the winding roller 74 is parallel to the X-axis direction. The width dimension of the winding roller 74 in the X-axis direction is longer than the width dimension in the X-axis direction of the sheet P1 transported. The outer diameter of the winding roller 74 in the present embodiment is set within a range from 6 mm to 40 mm, for example, to 20 mm.

The transportation roller pair 79 (see FIG. 1) is located downstream of the winding roller 74. Driving of the transportation roller pair 79 and the processing roller pair 71 is controlled by the control unit 5 such that tension can be applied to the sheet P1 during transportation of the sheet P1.

Thus, the winding portion Aw, on which the sheet P1 formed at the nipping portion An is wound, is formed on the first roller 72 by the transportation performed by the transportation roller pair 79 and the processing roller pair 71. This enables the web W to be pressed and heated in the nipping portion An and the sheet P1 to be heated on the winding portion Aw, simultaneously.

The first roller 72 heating the first side Fa of the sheet P1 on the winding portion Aw promotes drying of the sheet P1, evaporating the moisture contained in the sheet P1. Evaporation of the moisture contained in the sheet P1 reduces the occurrence of deformation and wrinkles due to the stress during transportation. On the winding portion Aw, the sheet P1 is put into a state in which the fibers have been sufficiently bonded to one another with gelatinized starch interposed therebetween.

The wound length Lw which corresponds to the length dimension of the winding portion Aw in the transportation direction is set such that the moisture content of the portion of the sheet P1 wound around the winding portion Aw can reach the equilibrium moisture content or less by heating of the first roller 72. This reduces deformation and transportation failure of the sheet P1 formed by the forming unit 70, which could occur downstream in the transportation direction. For example, the wound length Lw in the present embodiment is set within a range from 50 mm to 100 mm, for example, to 75 mm. Note that the equilibrium moisture content denotes the moisture content of a material such as the sheet P1 that has reached equilibrium with its atmosphere in air having a constant temperature and humidity.

In the process of the moisture content of the portion of the sheet P1 wound around the winding portion Aw reaching the equilibrium moisture content, the contraction of the sheet P1 in moisture evaporation can cause deformation of the sheet P1 such as wrinkles. To address this, the forming unit 70 in the present embodiment includes the pressing mechanism 75 including the pressing roller 762. The pressing roller 762 is located at a position facing the winding portion Aw on the transportation path.

The first roller 72 heating the sheet P1 causes moisture to evaporate from the second side Fb of the sheet P1 on the winding portion Aw. When a gap between the second roller 73 and the pressing roller 762 and a gap between the pressing roller 762 and the winding roller 74 are small, moisture does not easily evaporate from the sheet P1 on the winding portion Aw.

The outer diameter of the pressing roller 762 is set such that the gaps mentioned above can be sufficient. Hence, the outer diameter of the pressing roller 762 is set smaller than the outer diameter of the second roller 73 so that the nipping length In can be sufficient. In the present embodiment, the pressing mechanism 75 includes not only the pressing roller 762 but also pressing rollers 761 and 763. Hence, the pressing mechanism 75 in the present embodiment includes the plurality of pressing rollers 761, 762, and 763.

In this case, when the forgoing gaps and the gaps between the pressing rollers 761, 762, and 763 are small, moisture does not easily evaporate from the sheet P1 on the winding portion Aw. The outer diameters of the pressing rollers 761, 762, and 763 are set such that the forgoing gaps and the gaps between the pressing rollers 761, 762, and 763 can be sufficient. Hence, the outer diameters of the pressing rollers 761, 762, and 763 are set smaller than the outer diameter of the second roller 73. The outer diameters of the pressing rollers 761, 762, and 763 in the present embodiment are the same.

The plurality of pressing rollers 761, 762, and 763 are located in this order from upstream in the transportation direction, at certain intervals. The pressing rollers 761, 762, and 763 are located between the processing roller pair 71 and the winding roller 74 on the transportation path. The pressing rollers 761, 762, and 763 are located at positions facing the winding portion Aw on the transportation path.

The pressing mechanism 75 includes a pressing-roller moving mechanism 77 configured to move the pressing rollers 761, 762, and 763 between a pressing position B1 and a spaced position B2. At the pressing position B1, the pressing rollers 761, 762, and 763 press the sheet P1 wound around the first roller 72 against the winding portion Aw of the first roller 72. This configuration forms a nipping portion Au between each of the pressing rollers 761, 762, and 763 and the first roller 72.

The pressing rollers 761, 762, and 763 are moved by the control unit 5 controlling driving of the pressing-roller moving mechanism 77.

Each nipping portion Au refers to the portion where the sheet P1 is pressed by one of the pressing rollers 761, 762, and 763 and the first roller 72, and each nipping length Lu (not illustrated) is the dimension of the nipping portion Au in the transportation direction of the sheet P1. Each nipping length Lu corresponds to the length dimension from the nipping start position at which one of the pressing rollers 761, 762, and 763 and the first roller 72 start nipping the sheet P1 to the nipping end position at which the same pressing roller and the first roller 72 end the nipping. The nipping length Lu is substantially uniform in the nipping portion Au in the X-axis direction.

The nipping portion Au of the pressing roller 762 is located downstream of the center of the winding portion Aw in the transportation direction. The nipping portion Au of the pressing roller 761 is located upstream of the center of the winding portion Aw in the transportation direction. The nipping portion Au of the pressing roller 763 is located downstream in the transportation direction of the center between the downstream end of the winding portion Aw and the nipping portion Au of the pressing roller 762.

At the spaced position B2, the pressing rollers 761, 762, and 763 are away from the sheet P1 and not in contact with the sheet P1.

The rotation axes of the pressing rollers 761, 762, and 763 are parallel to the X-axis direction. The pressing rollers 761, 762, and 763 are located on the −Y direction side of the transportation path on which the sheet P1 is transported. Hence, the spaced position B2 is located at a position away in the −Y direction from the pressing position B1. Hence, the pressing-roller moving mechanism 77 of the pressing mechanism 75 is located on the −Y direction side of the spaced position B2.

The pressing rollers 761, 762, and 763 are driven rollers that are not driven by a drive motor and follow the rotation of the first roller 72. When the first roller 72 rotates counterclockwise as viewed from the −X direction, the pressing rollers 761, 762, and 763 rotate clockwise.

The width dimensions of the pressing rollers 761, 762, and 763 in the X-axis direction are larger than the width dimension in the X-axis direction of the sheet P1 wound around the first roller 72. With this configuration, the pressing rollers 761, 762, and 763 can press the entire region of the sheet P1 in the X-axis direction against the winding portion Aw of the first roller 72. The width dimensions of the pressing rollers 761, 762, and 763 in the present embodiment in the X-axis direction are the same as the width dimension of the first roller 72 in the X-axis direction.

The pressing rollers 761, 762, and 763 each include, for example, a metal shaft 76c composed of aluminum, iron, stainless steel, or the like. The surface of the shaft 76c is covered with an elastic layer 76e composed of a rubber such as silicone rubber and urethane rubber.

When the rubber hardnesses of the elastic layers 76e are low, the ratio of the nipping portions Au to the winding portion Aw is high. When the ratio of the nipping portions Au to the winding portion Aw is high, moisture does not easily evaporate from the sheet P1 on the winding portion Aw.

Hence, the rubber hardnesses of the elastic layers 76e are set such that the moisture content of the portion of the sheet P1 wound around the winding portion Aw can reach the equilibrium moisture content or less by heating of the first roller 72.

Hence, the rubber hardnesses of the elastic layers 76e of the pressing rollers 761, 762, and 763 are set higher than the rubber hardness of the elastic layer 73e of the second roller 73 which is set low to make the nipping length Ln sufficient. The rubber hardnesses of the elastic layers 76e of the pressing rollers 761, 762, and 763 in the present embodiment are the same. It is preferable that the hardnesses of the elastic layers 76e be rubber hardness A40 or more and A70 or less, and it is more preferable that they be rubber hardness A50 or more and A60 or less.

It is preferable that the thicknesses of the elastic layers 76e be 1 mm or more and 4 mm or less, and it is more preferable that they be 1 mm or more and 2 mm or less. The surfaces of the elastic layers 76e are covered with surface layers 76s composed of a fluororesin layer or a tube containing a fluororesin.

Examples of the fluororesin that can be used include tetrafluoroethylene-perfluoroalkyl vinyl ether copolymer (PFA) and polytetrafluoroethylene (PTFE). Other examples of the fluororesin that can be used include tetrafluoroethylene-hexafluoropropylene copolymer (FEP) and tetrafluoroethylene-ethylene copolymer (ETFE). The surface layers 76s increase non-adhesiveness to the web W and the sheet P1. The surface layers 76s reduce wear and damage to the shafts 76c.

The sheet P1 is formed by pressing and heating the web W in the nipping portion An. Hence, the pressing loads of the pressing rollers 761, 762, and 763 for pressing the sheet P1 against the first roller 72 can be lower than the pressing load of the second roller 73 for pressing the web W against the first roller 72. The pressing loads of the pressing rollers 761, 762, and 763 in the present embodiment are set within a range from 20 N to 80 N, for example, to 60 N.

Hence, the pressure exerted on the sheet P1 by the pressing rollers 761, 762, and 763 pressing the sheet P1 against the first roller 72 is lower than the pressure exerted on the web W by the processing roller pair 71 nipping the web W.

The pressing rollers 761, 762, and 763 in the present embodiment each include, for example, the shaft 76c with a diameter of 10 mm, the elastic layer 76e with a thickness of 2 mm, and the surface layer 76s composed of a PFA tube with a thickness of 50 μm. The pressing rollers 761, 762, and 763 in the present embodiment each have an outer diameter of 14 mm. The nipping length Lu of the nipping portion Au formed by each of the pressing rollers 761, 762, and 763 and the first roller 72 is from 0.5 mm to 3 mm. Although it is preferable that the outer diameters of the pressing rollers 761, 762, and 763 be uniform in the width direction in view of preventing the occurrence of wrinkles, the pressing rollers 761, 762, and 763 may each have a portion the outer diameter of which is small. In this case, the pressing rollers 761, 762, and 763 may have, for example, a configuration of a stepped roller or split rollers.

The peeling portion 78 is located between the winding portion Aw of the first roller 72 and the winding roller 74 on the transportation path. The peeling portion 78 includes a peeling plate in the form of a thin plate. The width dimension of the peeling plate in the X-axis direction is larger than the width dimension in the X-axis direction of the sheet P1 wound around the first roller 72. Because the distal end of the peeling plate is in contact with the surface of the first roller 72, the sheet P1 wound around the winding portion Aw is peeled off the surface of the first roller 72.

The peeling portion 78 includes a peeling-plate moving mechanism (not illustrated) configured to move the peeling plate between a contact position C1 (see FIG. 3) at which the peeling plate is in contact with the surface of the first roller 72 and a retreat position C2 (see FIG. 2) at which the peeling plate is away from the surface of the first roller 72. The peeling plate is moved by the control unit 5 controlling driving of the peeling-plate moving mechanism.

The control unit 5 controlling the forming unit 70 causes the web W to pass through the nipping portion An and the winding portion Aw formed on the transportation path to form the web W into the sheet P1. When forming the web W into the sheet P1, the control unit 5 controls driving of the heaters 72h and 73h to keep the surface temperatures of the first roller 72 and the second roller 73 at specified temperatures. When forming the web W into the sheet P1, the control unit 5 controls driving of the second-roller moving mechanism to position the second roller 73 at the nipping position.

When forming the web W into the sheet P1, the control unit 5 controls driving of the transportation roller pair 79 and the first roller 72 to apply tension to the sheet P1. In this state, the first roller 72 rotates counterclockwise as viewed from the-X direction. When forming the web W into the sheet P1, the control unit 5 controls driving of the pressing-roller moving mechanism 77 to position the pressing rollers 761, 762, and 763 at the pressing position B1. When forming the web W into the sheet P1, the control unit 5 controls driving of the peeling-plate moving mechanism to position the peeling plate at either the contact position C1 or the retreat position C2.

As described above, the sheet manufacturing apparatus 1 according to Embodiment 1 provides the following advantageous effects.

The sheet manufacturing apparatus 1 includes the deposition unit 50 configured to deposit a material containing fibers to form a web W, and the forming unit 70 configured to press and heat the web W to form it into the sheet P1. The forming unit 70 includes the first roller 72 configured to heat the web W and the sheet P1, and the second roller 73 between which and the first roller 72 the web W is nipped. The forming unit 70 includes the winding roller 74 located downstream of the first roller 72 in the transportation direction in which the sheet P1 is transported and configured to wind the sheet P1 around the first roller 72. The forming unit 70 includes the pressing rollers 761, 762, and 763 configured to press the sheet P1 wound around the first roller 72 against the first roller 72.

This enables the forming unit 70 to manufacture the sheet P1 dried to have an equilibrium moisture content or less without causing deformation such as wrinkles. This reduces the occurrence of failure in transportation of the sheet P1 formed by the forming unit 70.

The pressing rollers 761, 762, and 763 have wider widths than the sheet P1. Thus, the sheet P1 wound around the first roller 72 can be pressed against the first roller 72 across the width dimension of the sheet P1.

When pressing the sheet P1 against the first roller 72, the pressing rollers 761, 762, and 763 rotate by being driven by the rotation of the first roller 72. This enables the sheet P1 wound around the first roller 72 to be stably pressed against the first roller 72.

The pressing rollers 761, 762, and 763 have smaller outer diameters than the second roller 73. This makes it easy to dry the sheet P1 wound around the first roller 72 by the first roller 72 heating the sheet P1.

The elastic layers 76e serving as the surfaces of the pressing rollers 761, 762, and 763 have higher hardnesses than the elastic layer 73e serving as the surface of the second roller 73. This makes it easy to dry the sheet P1 wound around the first roller 72 by the first roller 72 heating the sheet P1.

The pressure exerted on the sheet P1 by the pressing rollers 761, 762, and 763 pressing the sheet P1 against the first roller 72 is lower than the pressure exerted on the web W by the first roller 72 and the second roller 73 nipping the web W. This makes it easy to dry the sheet P1 wound around the first roller 72 by the first roller 72 heating the sheet P1.

The forming unit 70 includes the plurality of pressing rollers 761, 762, and 763 spaced in the transportation direction. This enables the distances in the transportation direction of the sheet P1 between the positions at which the sheet P1 is pressed against the first roller 72 to be smaller than when the forming unit 70 includes one pressing roller 762. This reduces the occurrence of deformation in the transportation direction of the sheet P1 such as wrinkles in the sheet P1 formed by the forming unit 70. This further reduces the occurrence of failure in transportation of the sheet P1 formed by the forming unit 70.

Although the sheet manufacturing apparatus 1 according to Embodiment 1 of the present disclosure described above has basically a configuration as described above, partial change, omission, or the like of the configuration is possible as a matter of course within a range not departing from the spirit of the present disclosure. Embodiment 1 described above and the following other embodiments can be combined for implementation within a range in which no technical contradictions arise. The following describes other embodiments.

In the aforementioned Embodiment 1, the nipping portion Au of the pressing roller 762 may be located at the center of the winding portion Aw in the transportation direction of the sheet P1. In this case, the winding portion Aw may be divided into four equal sections in the transportation direction by the nipping portions Au of the pressing rollers 761, 762, and 763.

In the aforementioned Embodiment 1, the second roller 73 can be considered as a kind of pressing roller. The forming unit 70 need not include all of the four pressing rollers 73, 761, 762, and 763. The forming unit 70 may include any three of the four pressing rollers 73, 761, 762, and 763 or may include any one or two of the four pressing rollers 73, 761, 762, and 763. Alternatively, the forming unit 70 may include five or more pressing rollers if gaps can be sufficiently set between the pressing rollers. When the forming unit 70 includes one pressing roller 762, the nipping portion Au of the pressing roller 762 may be located at the center of the winding portion Aw in the transportation direction of the sheet P1. In the aforementioned Embodiment 1, all of the plurality of pressing rollers may include heaters and perform heating, or only some of the rollers may include heaters and perform heating. Alternatively, the number of pressing rollers that include heaters and perform heating may be zero.

In the aforementioned Embodiment 1, the forming unit 70 may include center support portions for mitigating the deflections of the pressing rollers at the pressing position B1. For example, each center support portion may be a rotation roller in contact with a portion of the surface of the pressing roller 761, 762, or 763 on the opposite side of its rotation axis from the nipping portion Au. This rotation roller may be in contact with a portion of the surface of the pressing roller 761, 762, or 763 at the center position in the X-axis direction. This rotation roller may be a driven roller that is in contact with the surface of the pressing roller 761, 762, or 763 and follows the rotation of the same pressing roller.

In the aforementioned Embodiment 1, the outer diameters of the pressing rollers need not be the same. For example, the outer diameters of the pressing rollers may differ from one another. For example, a configuration in which the outer diameters of two of the pressing rollers 761, 762, and 763 are the same, and the outer diameter of the other one is different may be possible. In this case, for example, a configuration in which the outer diameters of the pressing rollers 762 and 763 are the same, and the outer diameter of the pressing roller 761 is smaller than those of the pressing rollers 762 and 763 is possible.

In the aforementioned Embodiment 1, the rubber hardnesses of the elastic layers 76e of the pressing rollers need not be the same. For example, the rubber hardnesses of the elastic layers 76e of the pressing rollers may differ from one another. For example, a configuration in which the rubber hardnesses of the elastic layers 76e of two of the pressing rollers 761, 762, and 763 are the same, and the rubber hardness of the elastic layer 76e of the other one is different is possible. In this case, for example, a configuration in which the rubber hardnesses of the elastic layers 76e of the pressing rollers 761 and 762 are the same, and the rubber hardness of the elastic layer 76e of the pressing roller 763 is lower than the rubber hardnesses of the elastic layers 76e of the pressing rollers 761 and 762 is possible.

In the aforementioned Embodiment 1, the pressing loads of the pressing rollers for pressing the sheet P against the first roller 72 need not be the same. For example, the pressing loads of the pressing rollers 761, 762, and 763 may differ from one another. For example, a configuration in which the pressing loads of two of the pressing rollers 761, 762, and 763 are the same, and the pressing load of the other one is different is possible. In this case, for example, a configuration in which the pressing loads of the pressing rollers 761 and 763 are the same, and the pressing load of the pressing roller 762 is higher than the pressing loads of the pressing rollers 761 and 763 is possible. Although the rollers for heating such as the first roller 72 and the second roller 73 include heaters within in the aforementioned Embodiment 1, the present disclosure is not limited to this configuration. For example, a heater outside a roller may heat the surface of the roller, and the heated roller may heat the web. Alternatively, the surface of a roller may serve as a heater, and the heater may directly heat the web.

What is claimed is:

1. A sheet manufacturing apparatus comprising:
a deposition unit configured to deposit a material containing fibers to form a web;
a humidification unit configured to moisten the formed web; and
a forming unit, wherein
the forming unit includes
a first roller configured to heat and dry the moistened web,
a winding roller configured to wind the web around the first roller, and
a pressing roller configured to press the web wound around the first roller against the first roller.

2. The sheet manufacturing apparatus according to claim 1, wherein
the pressing roller has a wider width than the web.

3. The sheet manufacturing apparatus according to claim 1, wherein
when pressing the web against the first roller, the pressing roller rotates by being driven by rotation of the first roller.

4. The sheet manufacturing apparatus according to claim 1, further comprising
a second roller that is located upstream of the pressing roller, between which and the first roller the web is nipped, and that heats the web.

5. The sheet manufacturing apparatus according to claim 4, wherein
the pressing roller has a smaller outer diameter than the second roller.

6. The sheet manufacturing apparatus according to claim 4, wherein
a surface of the pressing roller has a higher hardness than a surface of the second roller.

7. The sheet manufacturing apparatus according to claim 4, wherein
a pressure exerted on the web by the pressing roller pressing the web against the first roller is lower than a pressure exerted on the web by the first roller and the second roller nipping the web.

8. The sheet manufacturing apparatus according to claim 4, wherein
a surface of the first roller becomes hotter than a surface of the second roller, and
the surface of the second roller becomes hotter than a surface of the pressing roller.

9. The sheet manufacturing apparatus according to claim 1, wherein
the forming unit includes a plurality of the pressing rollers spaced in a transportation direction.

10. The sheet manufacturing apparatus according to claim 1, wherein
the forming unit further includes a peeling plate located downstream of the pressing roller and configured to peel the web off the first roller.

11. The sheet manufacturing apparatus according to claim 1, wherein
a surface of the first roller becomes hotter than a surface of the pressing roller.

12. The sheet manufacturing apparatus according to claim 1, wherein
the humidification unit moistens the web from a side of front and back sides of the web, the side being in contact with the first roller.

13. The sheet manufacturing apparatus according to claim 1, wherein
the deposition unit deposits a material containing fibers and starch to form the web.

14. A method of manufacturing a sheet, comprising:
depositing a material containing fibers to form a web;
moistening the web;
winding the moistened web around a first roller by using a winding roller;
pressing the web wound around the first roller against the first roller by using a pressing roller; and
heating and drying the moistened web by using the first roller.
